(19) United States
(12) Patent Application Publication
(10) Pub. No.: US 2026/0311448 A1
(43) Pub. Date: Oct. 8, 2026

(54) ANALYZING SEMANTIC USER SESSIONS USING SCREEN UNDERSTANDING

(71) Applicant: Microsoft Technology Licensing, LLC, Redmond, WA (US)

(72) Inventors: Eric Chris Wolfgang SOMMERLADE, Oxford (GB); Justin James WAGLE, Pacifica, CA (US); Sunando SENGUPTA, Reading (GB); Rajath Kumar RAVI, Reading (GB)

(73) Assignee: Microsoft Technology Licensing, LLC, Redmond, WA (US)

(21) Appl. No.: 19/170,440

(22) Filed: Apr. 4, 2025

(51) Int. Cl. G06V 10/74; G06F 16/334; G06F 16/338; G06F 40/295; G06F 40/30; G06V 10/26; G06V 10/40; G06V 10/82; G06V 30/148; G06V 30/18; G06V 30/19

(52) U.S. Cl. CPC G06V 10/761; G06F 16/3344; G06F 16/338; G06F 40/295; G06F 40/30; G06V 10/26; G06V 10/40; G06V 10/82; G06V 30/148; G06V 30/18; G06V 30/19093

(57) ABSTRACT

Techniques and related implementations for analyzing semantic sessions are provided. One implementation includes a computing system comprising: processing circuitry and memory storing instructions that, during execution, cause the processing circuitry to perform the steps of: receiving a plurality of screenshot images; for each of the plurality of screenshot images: identifying one or more image regions and one or more text regions on the screenshot image; and generating features for the screenshot image based on the one or more image regions and the one or more text regions using an artificial intelligence module; generating a user activity graph comprising nodes and edges, wherein the nodes correspond to the plurality of screenshot images, and wherein the edges correspond to commonalities between node pairs based on the generated features of the plurality of screenshot images; and identifying one or more node clusters from the user activity graph based on semantic relationships.

### BACKGROUND

A screenshot, also referred to as a screen image capture, is a digital image that shows the contents of a computing device's graphical output/display screen at a specific point in time. Screenshots provide a convenient way of capturing and storing information from the user's screen, such as web pages, documents, messages, images, etc. Capturing a screenshot can be performed in various ways, including through the use of built-in operating system features and/or dedicated software. Depending on the method used and/or preference settings, a screenshot can capture the entire screen or a selected portion of said screen.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Techniques and related implementations for analyzing semantic sessions are provided. One implementation includes a computing system comprising: processing circuitry and memory storing instructions that, during execution, cause the processing circuitry to perform the steps of: receiving a plurality of screenshot images; for each of the plurality of screenshot images; identifying one or more image regions and one or more text regions on the screenshot image, and generating features for the screenshot image based on the one or more image regions and the one or more text regions using an artificial intelligence module; generating a user activity graph comprising nodes and edges, wherein the nodes correspond to the plurality of screenshot images, and wherein the edges correspond to commonalities between node pairs based on the generated features of the plurality of screenshot images; and identifying one or more node clusters from the user activity graph based on semantic relationships.

### BRIEF DESCRIPTION OF THE DRAWINGS

FIG. 1 shows a schematic view of an example computing system for analyzing semantic user sessions using screen understanding techniques.

FIG. 2 shows a data flow diagram for grouping screenshot images into semantic user sessions, which can be implemented using the example computing system of FIG. 1.

FIG. 3 shows a data flow diagram for extracting features from screenshot images, which can be implemented using the example computing system of FIG. 1.

FIG. 4 shows a data flow diagram for determining semantic sessions from screenshot images and their features, which can be implemented using the example computing system of FIG. 1.

FIG. 5 shows a process flow diagram of an example method for analyzing semantic user sessions using screen understanding techniques, which can be implemented using the example computing system of FIG. 1.

FIG. 6 shows a schematic view of an example computing environment in which the computer system of FIG. 1 may be enacted.

### DETAILED DESCRIPTION

Screenshots are a common way of capturing and storing information from a computer screen, allowing users to revisit such information and/or share them with others. Screenshots are often stored without much structure, typically sorted by a filename containing timestamp information. This lack of organization makes it difficult for users to search for information when trying to revisit/recall a previous session of computer usage. Current solutions for providing a screenshot organizational scheme include techniques for clustering screenshots into different user sessions, providing a basic storage structure that allows users to search through screenshots for information pertaining to a given user session. A user session can be defined as a period of user activity. Current methods for determining a user session generally use heuristics based solely on time. Screenshots within a contiguous period of time are clustered as a user session. Although this naïve implementation provides a convenient mechanism for breaking up the timeline across a series of screenshot images, there can be logical inconsistencies when users are multi-tasking or are returning to a previous activity. For example, screenshots taken during a session where a user is multi-tasking, or performing more than one task, can be clustered together as they were likely taken during a contiguous period of time. However, the clustered user session would contain screenshots that may be irrelevant to one another.

In view of the observations above, implementations for identifying and analyzing semantic user sessions using screen understanding techniques are provided. Identifying and analyzing semantic user sessions can involve clustering screenshot images into sessions, connecting different sessions together, and/or generating summaries for sessions. Various tools, including but not limited to machine learning models, can be utilized. In some implementations, the semantic user sessions are modeled as a graph where screenshot images are represented as nodes and similarities between screenshot images are represented as edges. The graph can help identify semantic relationships, which can be used to cluster groups of screenshot images into semantic user sessions.

As used in this disclosure, a semantic user session is a period of user activity where the user performs semantically consistent actions. Semantically consistent actions are user activity characterized by actions that can be grouped together based on their content and context. For example, a user browsing the Internet may be performing actions consistent with a shopping session, which can result in screenshot images of different websites relating to a particular shopping session. These screenshot images can be clustered into a semantic user session that a user may access through keyword and metadata searching. Other examples of a semantic user session include sessions that can be described as “browsing social media,” “chatting,” “reviewing documents,” etc.

Screenshot images often contain rich semantic and topical information that is not captured and utilized as such information can be difficult to manually discern and/or extract. The techniques described herein take advantage of semantic and topical information from a series of screenshot images to cluster them into one or more semantic user sessions. Such information can be stored in a logical organizational scheme that provides powerful search capabilities, enabling users to revisit and find desired information. Semantic user session information can enable various applications and provide many different advantages. Users can find and access their sessions easily and quickly through search capabilities using natural language and/or image queries. Use of semantic user session information can enhance the user experience by providing users with personalized and relevant information extracted from their sessions. In some implementations, semantic user sessions can be connected with one another through various criteria, such as similar extracted information and/or metadata. Relating semantic user sessions can enhance the searching and/or personalized recommendation experience.

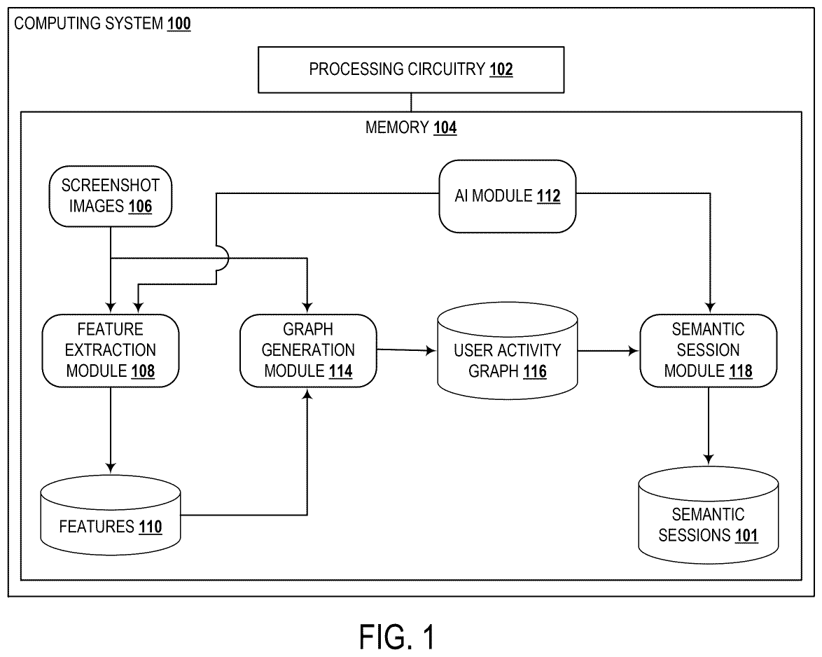

Turning now to the drawings, implementations for identifying and analyzing semantic user sessions using screen understanding techniques are described in further detail. FIG. 1 shows a schematic view of an example computing system 100 for analyzing semantic user sessions 101 using screen understanding techniques. The example computing system 100 includes processing circuitry 102 and memory 104 storing instructions that, during execution, cause the processing circuitry 102 to perform the processes described herein. The example computing system 100 can be implemented with one or more of various types of computing devices, including but not limited to personal computers, servers, and mobile devices. For example, the computing system 100 can include a plurality of computing devices, and processing circuitry 102 and memory 104 may each include multiple components spread across multiple computing devices (e.g., processing circuitry 102 can include multiple processors within a single device or spread across multiple devices). The devices may be locally and/or remotely located. In some implementations, the computing system 100 includes a backend server system. The example computing system 100 can also include non-depicted components for providing various functionalities, including components on individual computing devices.

Analyzing semantic user sessions 101 starts with receiving a plurality of screenshot images 106. Generally, a screenshot image 106 is a screen image capture in a digital format that shows the contents of a computing device's graphical output at a specific point in time. The screenshot images 106 can be provided in various ways. In some implementations, the screenshot images 106 are received from an external device. For example, the computing system 100 can be implemented as a backend system, providing processing capabilities to a frontend user device. In such cases, the screenshot images 106 can be generated from the user device and transmitted to the computing system 100. In some implementations, the computing system 100 is a user computing device, and the screenshot images 106 are generated locally. For example, the computing system 100 can include a graphical operating system with a graphical user interface. Graphical information can be captured at various points in time to generate the screenshot images 106.

Screenshot images 106 can be generated using various methods, including but not limited to the use of built-in operating system features and dedicated software. Each screenshot image 106 can capture graphical information for the entire screen or a portion thereof. The screenshot images 106 can be generated automatically and/or in response to a user command. For example, the computing system 100 can be configured to automatically acquire screenshot images 106 at regular (or irregular) intervals. Additionally or alternatively, the screenshot images 106 can be acquired manually in response to user command.

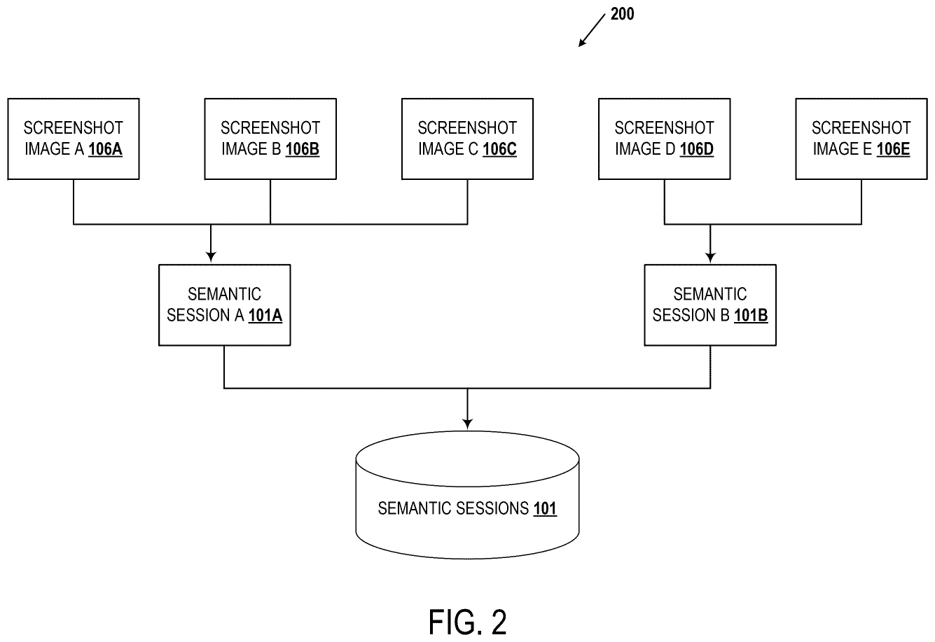

The screenshot images 106 can be grouped into semantic user sessions 101 based on their content. FIG. 2 shows a data flow diagram 200 for grouping screenshot images 106 into semantic user sessions 101. As shown, a first set of screenshot images 106A-106C is grouped into a first semantic user session 101A, and a second set of screenshot images 106D, 106E is grouped into a second semantic user session 101B. In the depicted example, the contents of the first set of screenshot images 106A-106C were found to be semantically similar, resulting in their identification as a single semantic user session. Semantic similarity can be based on various factors. For example, the first set of screenshot images 106A-106C may be temporally similar. Additionally or alternatively, they may have visual and/or textual similarity. Both semantic user sessions 101A, 101B are included in a grouping of semantic user sessions 101 that can be stored for various purposes. For example, users may perform keyword and/or metadata query to search for screenshot images relating to a semantic user session 101. In some implementations, semantic user sessions 101 can be linked to one another. As can readily be appreciated, the grouping of semantic user sessions 101 can contain any number of semantic user sessions.

Referring back to FIG. 1, identification of semantic user sessions 101 from the screenshot images 106 can be performed by analyzing a graph generated using the screenshot images 106 and their extracted information. In the depicted example, the computing system 100 includes a feature extraction module 108 for extracting features 110 from the screenshot images 106. A feature can include any information pertaining to a screenshot image 106. For example, the features 110 can include one or more of a textual embedding, a visual embedding, a classification, extracted text, or any other information relating to a respective screenshot image 106. The feature extraction module 108 can be implemented in various ways. In some implementations, the feature extraction module 108 includes one or more machine learning models trained to perform one or more tasks. In the depicted example, the computing system 100 implements an artificial intelligence (AI) module 112 that includes one or more machine learning models utilized for the analysis of semantic user sessions 101. For example, the AI module 112 can include a convolutional neural network configured to generate visual embeddings from an input image. The visual embeddings can be generated in various ways. In some implementations, the AI module 112 includes a vision machine learning model that extracts features from the input image and encodes them into a lower dimensional representation (a “latent space”) to generate the visual embeddings.

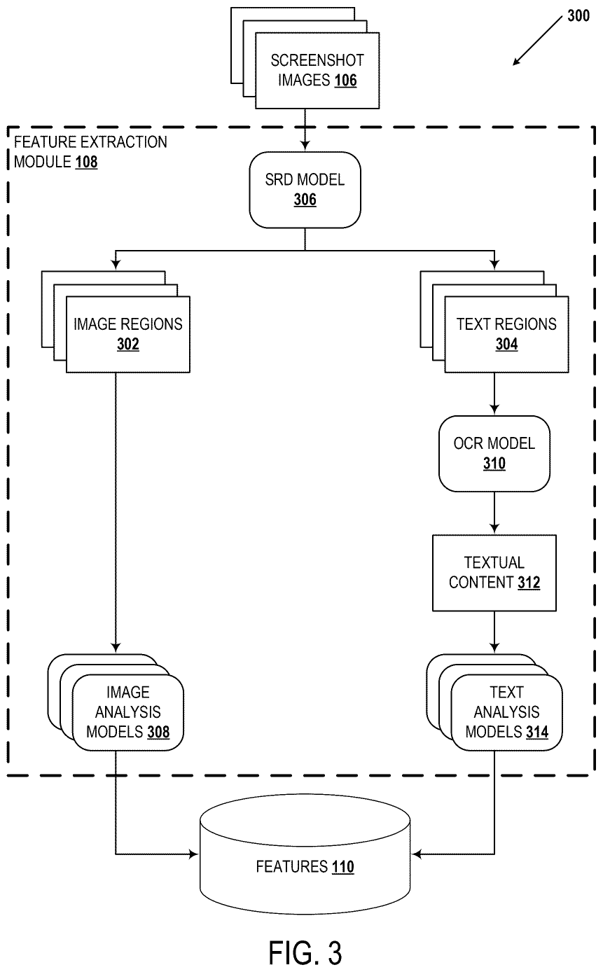

FIG. 3 shows a data flow diagram 300 for extracting features 110 from screenshot images 106. Features 110 can be extracted from the screenshot images 106 using a feature extraction module 108 that includes multiple models for performing various tasks. The feature extraction module 108 implements a feature extraction process for each of the screenshot images 106. The process starts with extracting one or more image regions 302 and/or one or more text regions 304 from a screenshot image 106. The regions 302, 304 can be extracted in various ways. In the depicted example, the feature extraction module 108 includes a screen region detection (SRD) model 306 configured to divide a screenshot image 106 into one or more image regions 302 and one or more text regions 304. The SRD model 306 can be implemented in various ways. In some implementations, the SRD model 306 includes a deep neural network trained to detect and classify boundaries of image and text regions. In some implementations, the SRD model 306 is designed to take a bitmap image of a window or other region of pixels and output rectangular regions identified as text, image, table, or various user interface classes. This model can be chained to other models for further processing or presented to users.

In the depicted example, the feature extraction module 108 further includes one or more image analysis models 308 for extracting features 110, such as visual embeddings, from the image regions 302. In some implementations, the image analysis models 308 are applied on a subset of the image regions 302. For example, a predetermined number of the image regions 302 is selected based on various criteria, such as selecting the five biggest image regions. In some implementations, the image regions 302 includes the entire respective screenshot image. Various types of image analysis models 308 can be utilized. For example, a vision machine learning model can be implemented to extract features and encode the features into visual embeddings represented in latent space. In some implementations, the feature extraction module 108 utilizes a multi-modal model. For example, a Florence image model can be implemented using a convolutional neural network that encodes the layout, color, and style of an input image into latent embeddings. Florence image embeddings can be generated by processing input images through a specialized vision encoder, such as the Dual Attention Vision Transformer (DaViT). The vision encoder extracts features and transforms them into visual embeddings in a latent space. In some implementations, the embeddings are represented as a tensor. A Florence image model can be implemented as a multi-modal model that can handle both images and text. The image embeddings can be normalized and projected to match the dimensionality of text embeddings. These embeddings can then be concatenated with text embeddings for multi-modal tasks, such as image captioning, visual question answering, image-text retrieval, etc.

Generally, the SRD model 306 extracts text regions 304 based on its ability to identify the presence of text. However, the extracted text regions 304 can still be in a graphical format. To address this, the feature extraction module 108 can implement an optical character recognition (OCR) model 310 that performs OCR to extract the textual content 312 of the text regions 304 in a text format—i.e., text characters recognizable by a computing device. In some implementations, the SRD model 306 is chained to the OCR model 310. The textual content 312 can include various types of information, including titles, headings, keywords, etc. To extract such information and store them as features, the feature extraction module 108 utilizes one or more text analysis models 314. In some implementations, the textual content 312 is concatenated text that is extracted using the OCR model 310. Various types of text analysis models 314 can be utilized. In some implementations, the text analysis models 314 include a semantic text model that generates textual embeddings from the textual content 312. A semantic text model is a sentence embedding model, such as a BERT sentence embedding model. In further implementations, the semantic text model includes a transformer-based neural network that encodes the meaning and context of the textual content 312.

The text analysis models 314 can also include models that identify keywords, extracting them or inferring other information from them to be used as features 110. For example, the text analysis models 314 can include a named entity recognition (NER) model that extracts named entities from the textual content 312. An NER model can be implemented using a transformer-based encoder-only model with a token classification head. The NER model can utilize a tagger that recognizes and classifies specific terms that refer to people, places, organizations, products, or events. For example, textual content 312 can be extracted from a screenshot image 106 acquired during a conference meeting. The NER model can recognize names from the extracted textual content 312 and include them as features 110 related to the respective screenshot image 106. This can relate names of meeting participants to a screenshot image 106 that can be clustered with other screenshot images containing similar participant names into a semantic user session corresponding to the conference meeting. Another example of a text analysis model 314 includes a topics model that extracts topics from the textual content 312. A topics model can be implemented as a transformer-based encoder-only model with a sequence classification head. The topics model can utilize a topic modeling technique that identifies the main subject or category of the textual content 312. For example, the topic can be “travel,” “sports,” “news,” etc.

In some implementations, the feature extraction module 108 includes a model that utilizes both visual and textual features of a screenshot image 106. For example, the feature extraction module 108 can include an activity detection model that predicts an activity label for each screenshot image 106. The activity detection model can be implemented in various ways. In some implementations, the activity detection model includes a classification model based on Florence embedding with a few-shot training. The activity detection model can utilize a machine learning model that utilizes a classifier to map the visual and textual features (e.g., features 110 extracted using the image analysis models 308 and the text analysis models 314) to a predefined set of activities, such as “meeting,” “coding,” “browsing,” etc. The determined activity can be stored as a feature 110 and utilized in various ways. For example, the activity tag can be used as a factor in grouping screenshot images 106 into semantic user sessions. In some implementations, screenshot images 106 belonging to a same semantic user session have the same activity tag. However, screenshot images 106 with the same activity tag are not necessarily grouped in the same semantic user session as different semantic user sessions may have the same activity (e.g., two different “meeting” sessions).

Referring back to FIG. 1, the computing system 100 further includes a graph generation module 114 for generating a user activity graph 116 using the screenshot images 106 and the extracted features 110. A graph-based representation can capture the semantic and structural relationships between the screenshot images 106 and their content. It can be used to identify the semantic relationships between the screenshot images 106 and, in turn, the semantic user sessions 101. In some implementations, the graph 116 is visualized and displayed to the user, graphically depicting the semantic and topical connections between screenshot images. By combining screen understanding and graph construction techniques, this approach for identifying semantic user sessions 101 enables the identification of sessions that occur at different points in time through the semantic edges of the graph 116.

The graph generation module 114 can be implemented in various ways. In some implementations, the graph generation module 114 includes a model that generates the graph 116 with nodes corresponding to the screenshot images 106 and edges corresponding to commonalities between node pairs based on the generated features 110. Each of the nodes can be assigned a unique identifier corresponding to a respective screenshot images 106. Each of the edges can represent semantic similarity between two respective nodes. For example, an edge connecting two nodes can be based on image similarity. A semantic user session can often involve use of an application (e.g., a semantic user session of “editing a document” can involve the use of a word processing application). In such cases, the corresponding screenshot images 106 can have visual similarity due to the application window likely being displayed for a substantial amount of time across the session.

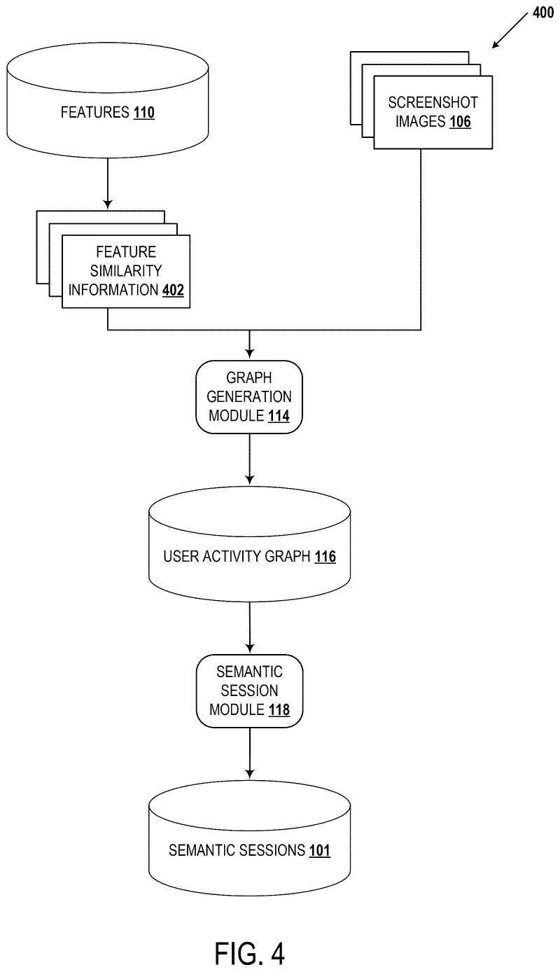

FIG. 4 shows a data flow diagram 400 for determining semantic sessions 101 from screenshot images 106 and their features 110. The process utilizes a graph generation module 114 to generate a user activity graph 116 that connects the screenshot images 106 based on similar features, including but not limited to semantic and visual similarities. The graph-based representation captures the semantic and structural relationships between the screenshot images 106 and their content. This enables a more nuanced process of identifying semantic user sessions 101. For example, compared to traditional methods that only account for time, semantic relationships can enable identification of a semantic user session 101 based on user activity that occurred at different points in time. Furthermore, consideration of semantic relationships as a factor enables the process to distinguish between two or more different semantic user sessions 101 that took place in a contiguous period of time (e.g., a user multi-tasking can perform two or more different semantic user sessions in a contiguous period).

The graph generation module 114 can be implemented in various ways. The graph generation module 114 can include a component that generates a set of nodes and a set of edges that make up the user activity graph 116. The nodes and edges can be generated in various ways. In some implementations, a node is generated for each of the screenshot images 106. Each of the nodes can be assigned a unique identifier associated with a respective screenshot image. Edges can be generated based on feature similarity information 402 derived from the extracted features 110. Feature similarity information 402 describes features that have similarity above a predetermined threshold and the screenshot images 106 associated with said features. Various feature similarity types can be utilized. For example, image similarity can be utilized. In such cases, an edge can be created between two nodes if they have a visual similarity above a predetermined threshold. This metric can be provided in various ways. In some implementations, the visual similarity of two screenshot images 106 is measured by the cosine similarity between their visual embeddings (e.g., Florence image embeddings). Similarly, an edge can be created between two nodes if they have a textual similarity above a predetermined threshold. In such cases, the textual similarity of two screenshot images 106 can be measured, for example, by the cosine similarity between their semantic text embeddings.

In some implementations, the user activity graph 116 includes hyper-edges. Hyper-edges can be advantageously utilized for feature types that can be shared among three or more nodes. For example, nodes corresponding to screenshot images 106 containing a similar named entity (e.g., extracted using a NER model) can be connected together using a hyper-edge. In another example, nodes having the same topic can be connected using a hyper-edge. In another example, nodes having the same activity can be connected using a hyper-edge. This approach enables compression of the user activity graph 116, providing storage space efficiency and query efficiency.

Referring back to FIG. 1, the computing system 100 further includes a semantic session module 118 for identifying semantic user sessions 101 from the generated user activity graph 116. The semantic session module 118 can be implemented in various ways. In the depicted example, the semantic session module 118 utilizes one or more machine learning models from the AI module 112 to identify semantic user sessions. The machine learning model can be tasked to identify nodes on the user activity graph 116 that are semantically similar based on their features 110. Various similarity criteria can be utilized. In some implementations, time is a factor in determining sessions. Temporally similar nodes with features that are similar enough can be clustered into a semantic user session. Semantic similarity of sessions can also be split across time based on graph connections—i.e., semantic similarity can be found between nodes/clusters of nodes with time gaps. Other considerations may also be used to determine more complex activities. For example, a contiguous period of usage may include more than one semantic user session based on the activity of the user. A user multi-tasking or performing back-to-back tasks may perform more than one set of semantically consistent actions in a contiguous period of screen usage. In such cases, utilizing time alone is not sufficient. Other semantic information can be utilized to segregate the semantic user sessions within the contiguous period of time.

In some implementations, metadata and/or extracted information from the screenshots are used to determine semantic user sessions. For example, nodes with similar activity classification, similar extracted text, etc. can be clustered. Combinations of factors can also be utilized. Some activities may require a similar temporal component. For example, a semantic user session relating to a “work meeting” may restrict nodes based on a contiguous time period. On the other hand, a semantic user session relating to “editing a document” may allow nodes with time gaps in between, signaling that the user took a break before returning to the same activity.

The semantic user session information 101 can be used in various ways. The semantic user sessions 101 can be displayed to a user as a rendered graph that depicts clusters of different semantic user sessions 101 and the connections between such sessions. In some implementations, summaries are generated for each session using captioning and summarization models. This provides quick access to information for a user. The semantic user session information 101 can enable users to perform natural language search queries to find information pertaining to a user session. For example, a user may query for the name of a person that attended a meeting. Features extracted from the relevant screenshot images 106 may have such information (e.g., OCR can be performed and text corresponding to names are extracted). The corresponding semantic user session may have been clustered based on such information—i.e., the corresponding semantic user session was clustered based on similar names found in extracted text. As a result, the query for the name of a person that attended a meeting can result in a return of screenshot images relating to said meeting.

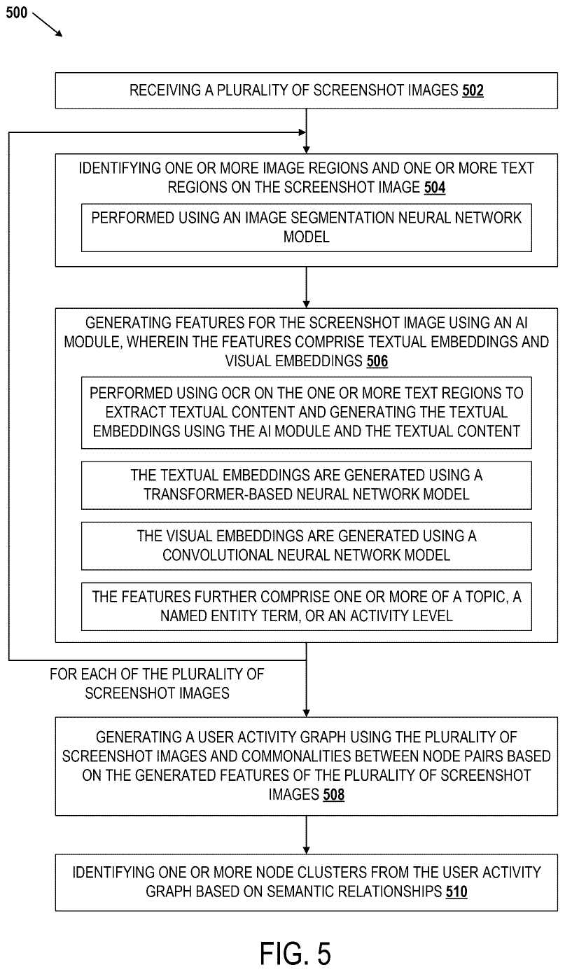

FIG. 5 shows a process flow diagram of an example method 500 for analyzing semantic user sessions using screen understanding techniques. The example method 500 includes, at step 502, receiving a plurality of screenshot images. The screenshot images can be received in various ways. In some implementations, the screenshot images are received from a remote computing device. For example, the example method 500 can be performed on a backend system providing processing and database capabilities to a frontend computing device. In such cases, the frontend computing device can acquire screenshot images and transmit them to the backend system for processing. In other implementations, the screenshot images are acquired on a local device implementing the example method 500.

The screenshot images can be acquired in various ways. In some implementations, built-in operating system features are used to capture screenshot images. Additionally or alternatively, dedicated software can also be utilized. Screenshot images can be acquired manually or automatically. For example, the screenshot images can be acquired in response to a user command, such as an input from a keyboard device. Dedicated software can be utilized to automatically capture screenshot images. In some implementations, the dedicated software is configured to acquire screenshot images at regular intervals. In further implementations, the software is configured to acquire screenshot images at regular intervals upon detection of user activity. Other settings may also be utilized.

The example method 500 includes, at step 504, identifying one or more image regions and one or more text regions on a screenshot image. The image regions and text regions can be identified using various methods, including both manual and automatic processes. One example of an automatic process that can be implemented includes the use of a screen region detection model. An SRD model is a model tasked to divide an input image into different regions. For example, the SRD model can be tasked to divide an input image into image regions and text regions. In some implementations, the image regions and text regions are identified using an image segmentation neural network model.

The example method 500 includes, at step 506, generating features for the screenshot image using an AI module. Generally, the features are extracted from the one or more image regions and the one or more text regions. In some implementations, an artificial intelligence module is utilized to extract features from the one or more image regions and the one or more text regions. Features can include one or more of a textual embedding, a visual embedding, a classification, extracted text, or any other information relating to the respective screenshot image.

The features can be generated in various ways, which can depend on the type of feature being generated. For example, textual embeddings can be extracted from the one or more text regions. Such a process can include first performing OCR on the one or more text regions to extract textual content that can be read by a computing device. The textual embeddings can then be derived from the textual content. In some implementations, the AI module includes a model to generate textual embeddings based on the textual content. For example, the AI module can utilize a semantic text model for generating textual embeddings based on the textual content. The semantic text model can be implemented using, for example, a transformer-based neural network model trained to encode meaning and context from text.

In addition to textual embeddings represented in the latent space, other types of features can also be extracted from the textual content. In some implementations, the AI module includes a named entity recognition model that extracts named entities from the textual content. The extracted named entity can be included in the features to be generated. In some implementations, the AI module includes a topics model that extracts topics from the textual content. The topics model can use a topic modeling technique that identifies the main subject or category of the textual content.

Features can also be generated from the one or more image regions. In some implementations, the AI module includes one or more image analysis models for extracting visual embeddings from the one or more image regions. Various types of image analysis models can be utilized. For example, a vision machine learning model can be implemented to extract visual embeddings from the one or more image regions. In some implementations, a multi-modal model is implemented. For example, a Florence image model can be implemented using a convolutional neural network that encodes the attributes of an input image into latent embeddings. Example attributes include but are not limited to layout, color, and style of an input image.

Features can also be generated from other features. In some implementations, the AI module includes an activity detection model that predicts an activity label for each screenshot image based on features extracted from the one or more image regions and the one or more text regions. The activity detection model can be implemented in various ways. In some implementations, the activity detection model includes a machine learning model that uses a classifier that maps visual and textual embeddings (e.g., extracted from the one or more image regions and the one or more text regions) to a predefined set of activities.

Steps 504 and 506 can be performed for each of the plurality of screenshot images, resulting in a set of features for each screenshot image. The example method 500 includes, at step 508, generating a user activity graph using the plurality of screenshot images and commonalities between node pairs based on the generated features of the screenshot images. The user activity graph can be generated in various ways. In some implementations, a graph generation module is implemented to take, as input, the screenshot images and their features to generate the user activity graph. Nodes of the user activity graph can be generated from the screenshot images, wherein each node corresponds to a respective screenshot image. In some implementations, each of the nodes contains a unique identifier corresponding to a respective screenshot image.

Edges of the user activity graph can be generated from the features extracted from the plurality of screenshot images. Edges represent similarities between (or among in some cases) nodes based on one or more features. For example, an edge can be generated to connect two nodes based on their image similarity. In some implementations, an edge is generated to connect two nodes when their image similarity is above a predetermined threshold. Image similarity can be calculated in various ways. One way includes calculating the cosine similarity between visual embeddings. Similarly, text similarity can be utilized to generate edges, wherein text similarity is determined by the cosine similarity between textual embeddings. In some implementations, the user activity includes hyper-edges that connect three or more nodes. Such edges can be generated based on a commonality of features among the connected nodes. For example, a hyper-edge can connect three or more nodes based on a similarity that is one or more of a named entity, a topic, or an activity. As can readily be appreciated, any feature similarity can be utilized for the generation of edges in the user activity graph.

The example method 500 includes, at step 510, identifying one or more node clusters from the user activity graph based on semantic relationships. The node clusters can represent semantic user sessions. For example, the nodes can be clustered if their connectivity is above a predetermined threshold, indicating a desired level of similarity. In some implementations, limitations are placed upon the clustering process. For example, a similar activity can be required for nodes to be clustered. Identification of node clusters and semantic user sessions can be performed for various purposes. In some implementations, the user activity graph can be rendered and displayed to a user for easy visualization and understanding of the semantic and topical connections between screenshot images.

In some implementations, semantic user sessions are identified in response to a user query. For example, a user can provide a natural language query for information regarding a previous session. Node clusters can be identified based on the query, and results can be returned. In some implementations, the results are returned to the user in the form of screenshot images corresponding to the identified node cluster/semantic user session. Additionally or alternatively, semantic user sessions can be identified, and such information can be stored for querying. In further implementations, each of the identified semantic user sessions can be summarized to provide quick access to information. Semantic user sessions can be summarized in various ways. In some implementations, each of the screenshot images in a given semantic user session is passed through a multi-modal language model to generate captions. The captions can then be fed into a language model to generate a summary representing the given semantic user session. Session summaries can be embedded for better querying and retrieval.

In some embodiments, the methods and processes described herein may be tied to a computing system of one or more computing devices. In particular, such methods and processes may be implemented as a computer-application program or service, an application-programming interface (API), a library, and/or other computer-program product.

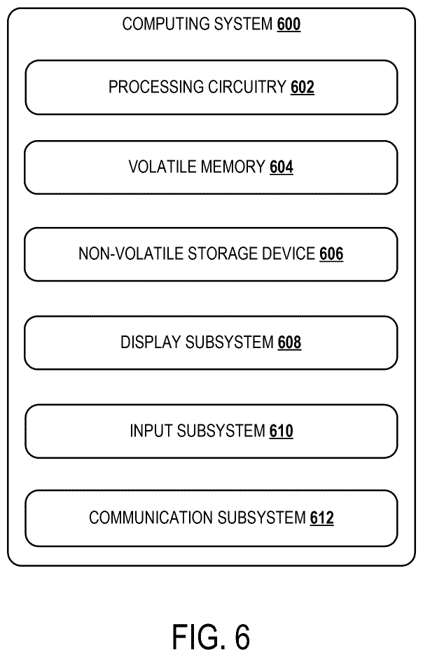

FIG. 6 schematically shows a non-limiting embodiment of a computing system 600 that can enact one or more of the methods and processes described above. Computing system 600 is shown in simplified form. Computing system 600 may embody the computing system 100 described above and illustrated in FIG. 1. Components of computing system 600 may be included in one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 600 includes processing circuitry 602, volatile memory 604, and a non-volatile storage device 606. Computing system 600 may optionally include a display subsystem 608, input subsystem 610, communication subsystem 612, and/or other components not shown in FIG. 6.

Processing circuitry 602 includes a logic processor that can be implemented with one or more physical devices configured to execute instructions. For example, the processing circuitry 602 may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The processing circuitry 602 may include one or more physical processors configured to execute software instructions. Additionally or alternatively, the processing circuitry 602 may include one or more hardware logic circuits or firmware devices configured to execute hardware-implemented logic or firmware instructions. Processors of the processing circuitry 602 may be single-core or multi-core, and the instructions executed thereon may be configured for sequential, parallel, and/or distributed processing. Individual components of the processing circuitry 602 optionally may be distributed among two or more separate devices, which may be remotely located and/or configured for coordinated processing. Aspects of the processing circuitry 602 may be virtualized and executed by remotely accessible, networked computing devices configured in a cloud-computing configuration. In such a case, these virtualized aspects are run on different physical logic processors of various different machines, it will be understood.

Non-volatile storage device 606 includes one or more physical devices configured to hold instructions executable by the processing circuitry 602 to implement the methods and processes described herein. When such methods and processes are implemented, the state of non-volatile storage device 606 may be transformed—e.g., to hold different data.

Non-volatile storage device 606 may include physical devices that are removable and/or built in. Non-volatile storage device 606 may include optical memory, semiconductor memory, and/or magnetic memory, or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by processing circuitry 602 to temporarily store information during processing of software instructions. It will be appreciated that volatile memory 604 typically does not continue to store instructions when power is cut to the volatile memory 604.

Aspects of processing circuitry 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via processing circuitry 602 executing instructions held by non-volatile storage device 606, using portions of volatile memory 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with processing circuitry 602, volatile memory 604, and/or non-volatile storage device 606 in a shared enclosure, or such display devices may be peripheral display devices.

When included, input subsystem 610 may comprise or interface with one or more user-input devices such as a keyboard, mouse, touch screen, camera, or microphone.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 600 to send and/or receive messages to and/or from other devices via a network such as the Internet.

The following paragraphs provide additional description of the subject matter of the present disclosure. One example includes a computing system for analyzing semantic sessions, the computing system comprising: processing circuitry and memory storing instructions that, during execution, cause the processing circuitry to perform the steps of: receiving a plurality of screenshot images; for each of the plurality of screenshot images: identifying one or more image regions and one or more text regions on the screenshot image, and generating features for the screenshot image based on the one or more image regions and the one or more text regions using an artificial intelligence (AI) module, wherein the features comprise textual embeddings and visual embeddings of the screenshot image; generating a user activity graph comprising nodes and edges, wherein the nodes correspond to the plurality of screenshot images, and wherein the edges correspond to commonalities between node pairs based on the generated features of the plurality of screenshot images; and identifying one or more node clusters from the user activity graph based on semantic relationships. In this example, additionally or alternatively, identifying the one or more image regions and the one or more text regions on the screenshot image is performed using an image segmentation neural network model that segments the screenshot image into the one or more image regions and the one or more text regions. In this example, additionally or alternatively, the textual embeddings of the screenshot image are generated by: performing optical character recognition on the one or more text regions to extract textual content; and generating the textual embeddings of the screenshot image using the AI module and the textual content. In this example, additionally or alternatively, the AI module comprises a transformer-based neural network model that encodes meaning and context from text; and the textual embeddings are generated using the transformer-based neural network model and the textual content. In this example, additionally or alternatively, the AI module comprises a topics model that extracts topics from text using a topic modeling technique that identifies a subject of the text; the features for the screenshot image comprise one or more topics extracted from the textual content using the topics model; and the edges comprise a first edge that is generated based on similar topics of a corresponding node pair. In this example, additionally or alternatively, the AI module comprises a named entity recognition model that extracts named entity from text; the features for the screenshot image comprise one or more named entity terms extracted from the textual content using the named entity recognition model; and the edges comprise a first edge that is generated based on similar named entity terms of a corresponding node pair. In this example, additionally or alternatively, the AI module comprises a convolutional neural network model that encodes attributes of images; and the visual embeddings of the screenshot image are generated using the convolutional neural network model and the one or more image regions. In this example, additionally or alternatively, the AI module comprises an activity detection model that predicts an activity label for a given image; the features for the screenshot image comprise one or more activity labels predicted by the activity detection model using the textual embeddings and the visual embeddings; and the edges comprise a first edge that is generated based on similar activity labels of a corresponding node pair. In this example, additionally or alternatively, the edges are generated based on image similarity or text similarity. In this example, additionally or alternatively, the image similarity is measured by cosine similarity between the visual embeddings, and wherein the text similarity is measured by cosine similarity between the textual embeddings.

Another example includes a method for analyzing semantic sessions, the method comprising: receiving a plurality of screenshot images; for each of the plurality of screenshot images: identifying one or more image regions and one or more text regions on the screenshot image, and generating features for the screenshot image based on the one or more image regions and the one or more text regions using an artificial intelligence (AI) module, wherein the features comprise textual embeddings and visual embeddings of the screenshot image; generating a user activity graph comprising nodes and edges, wherein the nodes correspond to the plurality of screenshot images, and wherein the edges correspond to commonalities between node pairs based on the generated features of the plurality of screenshot images; and identifying one or more node clusters from the user activity graph based on semantic relationships. In this example, additionally or alternatively, identifying the one or more image regions and the one or more text regions on the screenshot image is performed using an image segmentation neural network model that segments the screenshot image into the one or more image regions and the one or more text regions. In this example, additionally or alternatively, the textual embeddings of the screenshot image are generated by: performing optical character recognition on the one or more text regions to extract textual content; and generating the textual embeddings of the screenshot image using the AI module and the textual content. In this example, additionally or alternatively, the AI module comprises a transformer-based neural network model that encodes meaning and context from text; and the textual embeddings are generated using the transformer-based neural network model and the textual content. In this example, additionally or alternatively, the AI module comprises a topics model that extracts topics from text using a topic modeling technique that identifies a subject of the text; the features for the screenshot image comprise one or more topics extracted from the textual content using the topics model; and the edges comprise a first edge that is generated based on similar topics of a corresponding node pair. In this example, additionally or alternatively, the AI module comprises a named entity recognition model that extracts named entity from text; the features for the screenshot image comprise one or more named entity terms extracted from the textual content using the named entity recognition model; and the edges comprise a first edge that is generated based on similar named entity terms of a corresponding node pair. In this example, additionally or alternatively, the AI module comprises a convolutional neural network model that encodes attributes of images; and the visual embeddings of the screenshot image are generated using the convolutional neural network model and the one or more image regions. In this example, additionally or alternatively, the AI module comprises an activity detection model that predicts an activity label for a given image; the features for the screenshot image comprise one or more activity labels predicted by the activity detection model using the textual embeddings and the visual embeddings; and the edges comprise a first edge that is generated based on similar activity labels of a corresponding node pair. In this example, additionally or alternatively, the edges are generated based on image similarity or text similarity; and the image similarity is measured by cosine similarity between the visual embeddings, and wherein the text similarity is measured by cosine similarity between the textual embeddings.

Another example includes a computing system for analyzing semantic sessions, the computing system comprising: processing circuitry and memory storing instructions that, during execution, cause the processing circuitry to perform the steps of: generating a user activity graph comprising nodes and edges, wherein the nodes correspond to a plurality of screenshot images, and wherein the edges correspond to commonalities between node pairs based on features of the plurality of screenshot images; receiving a search query; identifying a node cluster from the user activity graph based on semantic relationships relevant to the search query; and presenting search results comprising one or more relevant screenshot images selected from the plurality of screenshot images corresponding to the node cluster.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for analyzing semantic sessions, the computing system comprising:
processing circuitry and memory storing instructions that, during execution, cause the processing circuitry to perform the steps of:
receiving a plurality of screenshot images;
for each of the plurality of screenshot images:
identifying one or more image regions and one or more text regions on the screenshot image, and
generating features for the screenshot image based on the one or more image regions and the one or more text regions using an artificial intelligence (AI) module, wherein the features comprise textual embeddings and visual embeddings of the screenshot image;
generating a user activity graph comprising nodes and edges, wherein the nodes correspond to the plurality of screenshot images, and wherein the edges correspond to commonalities between node pairs based on the generated features of the plurality of screenshot images; and
identifying one or more node clusters from the user activity graph based on semantic relationships.

2. The computing system of claim 1, wherein identifying the one or more image regions and the one or more text regions on the screenshot image is performed using an image segmentation neural network model that segments the screenshot image into the one or more image regions and the one or more text regions.

3. The computing system of claim 1, wherein the textual embeddings of the screenshot image are generated by:
performing optical character recognition on the one or more text regions to extract textual content; and
generating the textual embeddings of the screenshot image using the AI module and the textual content.

4. The computing system of claim 3, wherein:
the AI module comprises a transformer-based neural network model that encodes meaning and context from text; and
the textual embeddings are generated using the transformer-based neural network model and the textual content.

5. The computing system of claim 3, wherein:
the AI module comprises a topics model that extracts topics from text using a topic modeling technique that identifies a subject of the text;
the features for the screenshot image comprise one or more topics extracted from the textual content using the topics model; and
the edges comprise a first edge that is generated based on similar topics of a corresponding node pair.

6. The computing system of claim 3, wherein:
the AI module comprises a named entity recognition model that extracts named entity from text;
the features for the screenshot image comprise one or more named entity terms extracted from the textual content using the named entity recognition model; and
the edges comprise a first edge that is generated based on similar named entity terms of a corresponding node pair.

7. The computing system of claim 1, wherein:
the AI module comprises a convolutional neural network model that encodes attributes of images; and
the visual embeddings of the screenshot image are generated using the convolutional neural network model and the one or more image regions.

8. The computing system of claim 1, wherein:
the AI module comprises an activity detection model that predicts an activity label for a given image;
the features for the screenshot image comprise one or more activity labels predicted by the activity detection model using the textual embeddings and the visual embeddings; and
the edges comprise a first edge that is generated based on similar activity labels of a corresponding node pair.

9. The computing system of claim 1, wherein the edges are generated based on image similarity or text similarity.

10. The computing system of claim 9, wherein the image similarity is measured by cosine similarity between the visual embeddings, and wherein the text similarity is measured by cosine similarity between the textual embeddings.

11. A method for analyzing semantic sessions, the method comprising:
receiving a plurality of screenshot images;
for each of the plurality of screenshot images:
identifying one or more image regions and one or more text regions on the screenshot image, and
generating features for the screenshot image based on the one or more image regions and the one or more text regions using an artificial intelligence (AI) module, wherein the features comprise textual embeddings and visual embeddings of the screenshot image;
generating a user activity graph comprising nodes and edges, wherein the nodes correspond to the plurality of screenshot images, and wherein the edges correspond to commonalities between node pairs based on the generated features of the plurality of screenshot images; and
identifying one or more node clusters from the user activity graph based on semantic relationships.

12. The method of claim 11, wherein identifying the one or more image regions and the one or more text regions on the screenshot image is performed using an image segmentation neural network model that segments the screenshot image into the one or more image regions and the one or more text regions.

13. The method of claim 11, wherein the textual embeddings of the screenshot image are generated by:
performing optical character recognition on the one or more text regions to extract textual content; and
generating the textual embeddings of the screenshot image using the AI module and the textual content.

14. The method of claim 13, wherein:
the AI module comprises a transformer-based neural network model that encodes meaning and context from text; and
the textual embeddings are generated using the transformer-based neural network model and the textual content.

15. The method of claim 13, wherein:
the AI module comprises a topics model that extracts topics from text using a topic modeling technique that identifies a subject of the text;
the features for the screenshot image comprise one or more topics extracted from the textual content using the topics model; and
the edges comprise a first edge that is generated based on similar topics of a corresponding node pair.

16. The method of claim 13, wherein:
the AI module comprises a named entity recognition model that extracts named entity from text;
the features for the screenshot image comprise one or more named entity terms extracted from the textual content using the named entity recognition model; and
the edges comprise a first edge that is generated based on similar named entity terms of a corresponding node pair.

17. The method of claim 11, wherein:
the AI module comprises a convolutional neural network model that encodes attributes of images; and
the visual embeddings of the screenshot image are generated using the convolutional neural network model and the one or more image regions.

18. The method of claim 11, wherein:
the AI module comprises an activity detection model that predicts an activity label for a given image;
the features for the screenshot image comprise one or more activity labels predicted by the activity detection model using the textual embeddings and the visual embeddings; and
the edges comprise a first edge that is generated based on similar activity labels of a corresponding node pair.

19. The method of claim 11, wherein:
the edges are generated based on image similarity or text similarity; and
the image similarity is measured by cosine similarity between the visual embeddings, and wherein the text similarity is measured by cosine similarity between the textual embeddings.

20. A computing system for analyzing semantic sessions, the computing system comprising:
processing circuitry and memory storing instructions that, during execution, cause the processing circuitry to perform the steps of:
generating a user activity graph comprising nodes and edges, wherein the nodes correspond to a plurality of screenshot images, and wherein the edges correspond to commonalities between node pairs based on features of the plurality of screenshot images;
receiving a search query;
identifying a node cluster from the user activity graph based on semantic relationships relevant to the search query; and
presenting search results comprising one or more relevant screenshot images selected from the plurality of screenshot images corresponding to the node cluster.
